(19) United States
(12) Patent Application Publication
(10) Pub. No.: US 2016/0352784 A1
(43) Pub. Date: Dec. 1, 2016

(54) METHOD AND DEVICE FOR PERFORMING COMMUNICATION SERVICE

(71) Applicant: SAMSUNG ELECTRONICS CO., LTD., Suwon-si (KR)

(72) Inventor: Jung-hyun OH, Seongnam-si (KR)

(73) Assignee: SAMSUNG ELECTRONICS CO., LTD., Suwon-si (KR)

(21) Appl. No.: 15/168,888

(22) Filed: May 31, 2016

(30) Foreign Application Priority Data
May 29, 2015 (KR) 10-2015-0076482

(51) Int. Cl. H04L 29/06; H04W 4/02; H04L 29/08

(52) U.S. Cl. CPC H04L 65/1069; H04L 67/12; H04W 4/02

(57) ABSTRACT

A method of performing a communication service includes: requesting, by a first device, a second device for data; receiving, by the first device, the data from the second device; and generating, by the first device, new data by filtering the data received from the second device based on a filtering criterion and combining the filtered data.

### CROSS-REFERENCE TO RELATED PATENT APPLICATION

This application claims priority from Korean Patent Application No. 10-2015-0076482, filed on May 29, 2015, in the Korean Intellectual Property Office, the disclosure of which is incorporated herein in its entirety by reference.

### BACKGROUND

### 1. Field

Apparatuses and methods consistent with the exemplary embodiments relate to performing a communication service, and more particularly, to generating new data by collecting data from various devices around the device and by filtering the collected data.

### 2. Description of the Related Art

Society has gone through the industrial revolution and the computerization revolution and is now entering an Internet of Things (IoT)-based hyperconnectivity revolution in which all ‘things’ will be connected to the Internet. Only less than 1% of all ‘things’ are currently connected to the Internet, but various innovations and various business opportunities may be created with the future expansion of IoT connectivity.

An example of IoT services includes emergency rescue message automatic transmission and an unmanned autonomous driving service. As another example of IoT service, health care products support health care services by measuring a heartbeat, a motion quantity, and the like of a human. As an aspect of a smart home, home appliances support services such as remote control of home appliances or a home closed-circuit television (CCTV) system.

### SUMMARY

One or more exemplary embodiments provide a first device that performs communication requests a second apparatus for data, receives the data from the second apparatus, filters the received data based on a preset filtering criterion, and combines the received data to generate new data.

One or more exemplary embodiments provide devices which arrange, search, and classify new data generated via a combination of received data and utilize the new data as various new content items.

Additional aspects will be set forth in part in the description which follows and, in part, will be apparent from the description, or may be learned by practice of the presented embodiments.

According to an aspect of an exemplary embodiment, a method of performing a communication service is performed by a first device and includes requesting a second device for data, wherein the requesting is performed by the first device; receiving data from the second device, wherein the receiving is performed by the first device; and generating new data by filtering the data received from the second device according to a preset filtering criterion and by combining the data received from the second device with each other, wherein the generating of the new data is performed by the first device.

The preset filtering criterion may be about whether the received data corresponds to at least one of location information of the first device, environment information about a location of the first device, and information about an application currently being executed by the first device.

The method may further include searching for the second device, wherein the searching is performed by the first device; and connecting a session with the found second device, wherein the connecting is performed by the first device.

The searching for of the second device by the first device may include receiving information about the second device from a third device that stores the information about the second device.

The connecting of the session with the second device by the first device may be connecting the session between the first device and the second device via a third device.

The requesting, by the first device, of the second device for the data may include transmitting a data request message to the second device, wherein the transmitting is performed by the first device. The receiving, by the first device, of the data from the second device may include receiving data in response to the data request message transmitted by the first device.

The receiving, by the first device, of the data from the second device may include receiving data in response to the data request message transmitted by the first device, at preset time intervals.

The generating of the new data may include generating new data that satisfies a filtering criterion set by a user of the first device, with respect to information stored in the storage and the received data.

The method may further include storing the generated new data.

The storing of the generated new data may include arranging and storing the generated new data according to services that are capable of using the generated new data.

The method may further include capturing an image; and combining the image captured by the first device with the generated new data.

According to an aspect of an exemplary embodiment, a first device for performing a communication service includes a communication interface configured to request a second device for data and receive the data from the second device; a controller configured to combine the data received from the second device with each other to generate new data according to a preset filtering criterion; and a storage configured to store the data received from the second device.

### BRIEF DESCRIPTION OF THE DRAWINGS

The above and/or other aspects will become more apparent by describing certain exemplary embodiments with reference to the accompanying drawings, in which:

FIG. 1 is a block diagram of a device according to an exemplary embodiment;

FIG. 2 is a block diagram of various devices according to an exemplary embodiment;

FIG. 3 is a flowchart of a method of generating new data, according to an exemplary embodiment;

FIGS. 4 and 5 illustrate examples in which a first apparatus receives information from another device, according to an exemplary embodiment;

FIG. 6 is a block diagram of a broker apparatus according to an exemplary embodiment;

FIG. 7 is a flowchart of a method, performed by a first apparatus, of discovering a second apparatus, according to an exemplary embodiment;

FIGS. 8 and 9 illustrate examples in which the first apparatus receives data, according to an exemplary embodiment;

FIG. 10 illustrates a method of performing a pathfinding service, according to an exemplary embodiment;

FIG. 11 is a flowchart of a method of performing pathfinding, according to an exemplary embodiment;

FIG. 12 illustrates a method of generating metadata, according to an exemplary embodiment;

FIG. 13 illustrates an example of metadata, according to an exemplary embodiment;

FIG. 14 illustrates a method of generating metadata, according to an exemplary embodiment;

FIG. 15 is a flowchart of a method of generating metadata, according to an exemplary embodiment; and

FIG. 16 is a table for describing a method of generating sensory temperature information, according to an exemplary embodiment.

### DETAILED DESCRIPTION

Certain exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

Throughout the specification, when an element is referred to as being “connected” or “coupled” to another element, it can be directly connected or coupled to the other element, or can be electrically connected or coupled to the other element with intervening elements interposed therebetween. In addition, the terms “comprises” and/or “comprising” or “includes” and/or “including” when used in this specification, specify the presence of stated elements, but do not preclude the presence or addition of one or more other elements.

A sensing technology, a wired/wireless communication and network infrastructure technology, and an IoT service interface technology are major components of the IoT technologies. The sensing technology denotes remote sensing using a traditional temperature/humidity/heat/gas/illumination/ultrasound sensors, and non-remote sensing by a physical sensor capable of obtaining information from physical objects and a surrounding environment, such as a synthetic aperture radar (SAR), radar, a position sensor, a motion sensor, and an image sensor. The physical sensor is being developed as a smart sensor equipped with a standardized interface and having an information processing capability in order to improve application characteristics. The physical sensor includes a virtual sensing function of extracting specific information from already-sensed data. A virtual sensing technology is realized via an actual IoT service interface. Since the IoT sensing technology uses a multi (multi-field) sensor technology that is one dimension higher than an independent and individual standard sensor, higher quality and higher-dimensional information may be extracted.

The wired/wireless communication and networking device of IoT may be any wired/wireless network capable of connecting a human, a thing, and a service to one another, such as existing Wireless Personal Area Networks (WPANs), Wi-Fi, 3G/4G/LTE, Bluetooth, Ethernet, a Broadband convergence network (BcN), satellite communication, Microware, serial communication, and Power Line Communication (PLC).

The IoT service interface links three major components (human/thing/service) of IoT to an application service for performing a specific function. In detail, the IoT service interface is not a concept of a network interface, but serves as an interface (e.g., storage, processing, and transformation) for providing a service such as information sensing, processing/extraction/handling, storage, determination, situation awareness, recognition, security/privacy protection, authentication/approval, discovery, object standardization, ontology-based semantic, an open sensor application programming interface (API), virtualization, location confirmation, processor management, an open platform technology, a middleware technology, a data mining technology, a web service technology, and a social network.

In an exemplary embodiment, a device may be a device (or a ‘thing’) that is connected to a gateway and applied to the Internet of Things (IoT). For example, the device may be a temperature sensor, a humidity sensor, an acoustic sensor, a motion sensor, a proximity sensor, a gas sensor, a heat sensor, a refrigerator, a closed-circuit TV (CCTV), a TV, a washing machine, a dehumidifier, a lamp, or a fire alarm. However, embodiments are not limited thereto.

The term ‘device’ may be interchangeably used with the term ‘apparatus’, and “a device” and “an apparatus” may be understood to have the same meaning as each other.

In an exemplary embodiment, apparatus information of a device represents the device and attributes of the device. For example, the device information of the device may include an identification (ID) value of the device, the type of the device, the type and attributes of sensing data sensed by the device, and information about a sensing cycle of the device.

In an exemplary embodiment, a service may include various services that are executable by a device. Examples of the service may include a service based on communication with a server or other devices, and a service that may be performed within the device. A service applicable to an exemplary embodiment is not limited to the aforementioned services, and may be understood as a broad concept service including various services executable by a device.

The service may also include all kinds of services that may be provided using information collected by a gateway. The service may be provided by a device and/or service that is communicable with a gateway. Examples of the service may include, but are not limited to, a home network service, a security service, a fire alarm service, a power management service, and a content sharing service. The service may also be provided by a gateway.

In an exemplary embodiment, examples of service information may include, but are not limited to, an ID value of a service, the types and number of devices for providing a service, the priorities of the devices for providing a service, the types and number of sensing data for providing a service, and the priorities of the sensing data for providing a service.

In an exemplary embodiment, a data transmission rule may be regarding how and from what device sensing data is to be received according to a resource occupancy rate of a gateway. The data transmission rule may include, for example, a device that is to be used for a service, a device that is to be stopped, a method of processing sensing data, a transmission cycle of the sensing data, and whether transmission of the sensing data is reserved.

Exemplary embodiments are applicable to all fields in which inter-apparatus communication is possible, as, for example, to the IoT, a ubiquitous service, a smart home, and a connected car service.

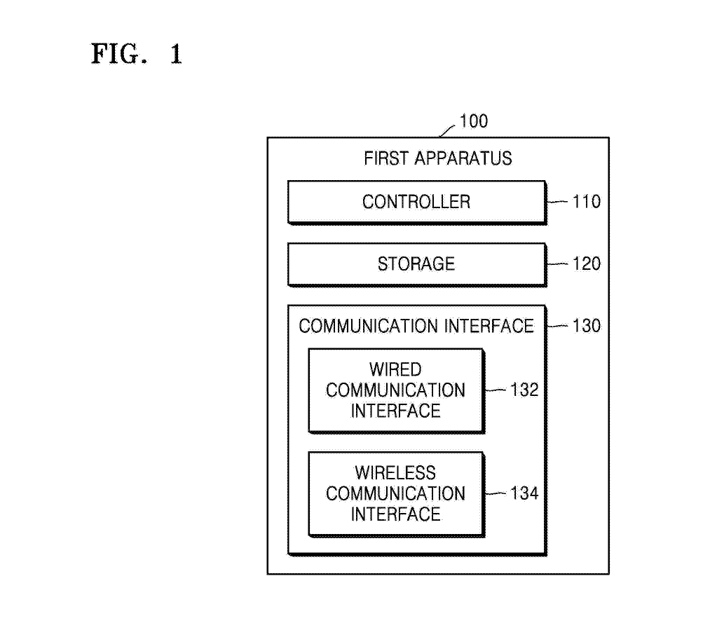

FIG. 1 is a block diagram of an apparatus 100, i.e., a first device, according to an exemplary embodiment.

The apparatus 100 may include an apparatus capable of inter-apparatus communication and may be any apparatus which is able to receive information of another apparatus, transmit information about the apparatus to the other apparatus, or transmit or receive information to or from the other apparatus.

The apparatus 100 may include a controller 110, e.g., a microprocessor, a storage 120, e.g., a storage device, and a communication interface 130. The communication interface 130 may include a wireless communication interface 132 and a wired communication interface 134.

The controller 110 may generate context information, based on information received from another device. The controller 110 may be set to transmit, to a server, the context information of the apparatus 100 and a request message with respect to a list of services that are executable by the apparatus 100. The controller 110 may generate a recommendation service user interface (UI) with respect to services received in response to the request message, on a screen by using a template preset in the apparatus 100.

The context information includes information about situations of a current user or device. For example, the context information may correspond to a location of a user of a current device, a pressure at the location, and illumination at the location. For example, the context information may correspond to an application being executed by the device, performance of the device, or information about an apparatus located around the device.

The controller 110 may be set to search for a second apparatus, e.g., a second device, that is around a first apparatus 100 and that is capable of providing information to the first apparatus 100.

The controller 110 may control the first apparatus 100 to search for the second apparatus according to various criteria. For example, the first apparatus 100 may search for all possible apparatuses. Since the first apparatus 100 does not know what information is to be received from what apparatus, the first apparatus 100 may search for all peripheral apparatuses around the first apparatus 100 in order to utilize all pieces of information.

For example, the first apparatus 100 may be controlled to search for a specific apparatus. The first apparatus 100 may search for only an apparatus corresponding to a smartphone, or search for only a CCTV camera whose location is fixed. For example, the first apparatus 100 may be set to search for only apparatuses that are within a certain radius, e.g., 30 meters (m), of the first apparatus 100. For example, the first apparatus 100 may measure the intensity of a reception signal and calculate the distance. For example, the first apparatus 100 may be set to search for only apparatuses that are owned by a user of the first apparatus 100.

The controller 110 may be set to transmit a discovery request message to peripheral apparatuses. The discovery request message may be transmitted as a broadcast, a multicast, or a unicast. The second apparatus that has received the discovery request message from the first apparatus 100 may transmit a discovery response message to the first apparatus 100 in response to the discovery request message. In response to the discovery response message, the first apparatus 100 may recognize the second apparatus and complete a discovery process. When a plurality of apparatuses are discovered, the discovery request message may be continuously transmitted.

The controller 110 may control the first apparatus 100 to perform session connection with a discovered second apparatus. Since the first apparatus 100 needs to receive various pieces of information from the second apparatus, session connection is necessary. The first apparatus 100 that has discovered N second apparatuses may maintain connection with each of the N second apparatuses. Alternatively, a broker apparatus, i.e., a third device, may exist between the first apparatus 100 and the N second apparatuses, and thus the first apparatus 100 may communicate with the broker apparatus and the broker apparatus may mediate connection between the first apparatus 100 and the N second apparatuses. For example, a first apparatus 100, which is a smartphone, may communicate with a broker apparatus corresponding to a server, and the server may be connected to a plurality of second apparatuses to be communicated therewith.

The controller 110 may be set to receive data from the second apparatus. The data received from the second apparatus may be sensing information measured by the second apparatus, or may be information stored in the second apparatus. For example, the data received from the second apparatus may be information received by the second apparatus from other apparatuses. For example, the first apparatus 100 may receive CCTV image data from a CCTV fixed to a particular location. As another example, the first apparatus 100 may receive subway traffic information from an apparatus of another user.

The controller 110 may determine whether the received data is within an error range. The received data may be data received according to a request of the first apparatus 100, or may be data received without request messages. Accordingly, the first apparatus 100 may perform filtering to improve purpose suitability and reliability of the data.

The controller 110 may generate new data, based on the received data. The controller 110 of the first apparatus 100 may generate context information, based on the received data and data pre-stored in the first apparatus 100.

The storage 120 may store information received from other devices and also store the generated context information. The storage 120 may also store information about a list of services executable by the apparatus 100, and information about a service list received from a server. The storage 120 may pre-store at least one template, and the template may be user interface (UI) information that is to be displayed on the screen to perform a service. The storage 120 may store, as a database (DB), an execution history of a service currently being executed.

The communication interface 130 may communicate with other apparatuses or sensors. The communication interface 130 may communicate with a network apparatus such as a server, and this communication may be performed by wires or wirelessly. The communication interface 130 may perform communication to receive sensing information of an apparatus such as a sensor apparatus and may perform communication to transmit information of the apparatus 100 to another device.

Examples of a network applicable to an exemplary embodiment may include a local area network (LAN), a wide area network (WAN), a value added network (VAN), a mobile radio communication network, a satellite communication network, and a combination thereof. The network is a data communication network that enables network configuring subjects to smoothly communicate with one another. Examples of the data communication network may include the wired Internet, the wireless Internet, and a mobile wireless communication network.

A device in an exemplary embodiment may perform a function of a portable terminal. Accordingly, examples of the device may include, but are not limited to, a smartphone, a tablet personal computer (PC), a PC, smart glasses, a smart TV, a personal digital assistant (PDA), a laptop, a media player, a micro-server, a global positioning system (GPS) device, an electronic book apparatus, a digital broadcasting apparatus, a navigation device, a kiosk, an MP3 player, a digital camera, and other mobile or non-mobile computing devices.

The device which includes a smartphone may perform communication via a cellular network or an Internet network. For example, the communication via a cellular network or an Internet network may correspond to a phone call, a short message service (SMS), or the Internet. A smartphone may include various modules and thus perform functions of a camera, a projector, a scanner, a printer, and the like.

The smartphone may perform various services by installing or using an OS of the smartphone or applications. The smartphone may perform various types of services, such as a financial service, a reservation service, and a sensing service, according to setting of functions of the smartphone or related applications.

The communication interface 130 may be configured to communicate with various types of external devices using various types of communication protocols. For example, the communication interface 130 may include at least one selected from a Wi-Fi chip (not shown), a Bluetooth chip (not shown), a wireless communication chip (not shown), and a NFC chip (not shown). The controller 110 may be configured to communicate with various external devices via the communication interface 130.

The Wi-Fi chip (not shown) and the Bluetooth chip (not shown) may perform communication via the Wi-Fi protocol and the Bluetooth protocol, respectively. In the case of using the Wi-Fi chip (not shown) or the Bluetooth chip (not shown), communication may be established by transmitting various connection information, such as SSIDs and session keys, first, and then various information may be transmitted and received. The wireless communication chip (not shown) may refer to a chip that performs communications via various communication protocols, such as IEEE, Zigbee, 3rd generation (3G), 3rd generation partnership project (3GPP), British Telecommunications (BT) and long-term evolution (LTE). The NFC chip (not shown) may refer to a chip that operates according to the near field communication (NFC) standard that uses a 13.56 MHz band from among various RF-ID frequency bands, such as 2040 kHz, 13.56 MHz, 433 MHz, 860-960 MHz, and 2.45 GHz.

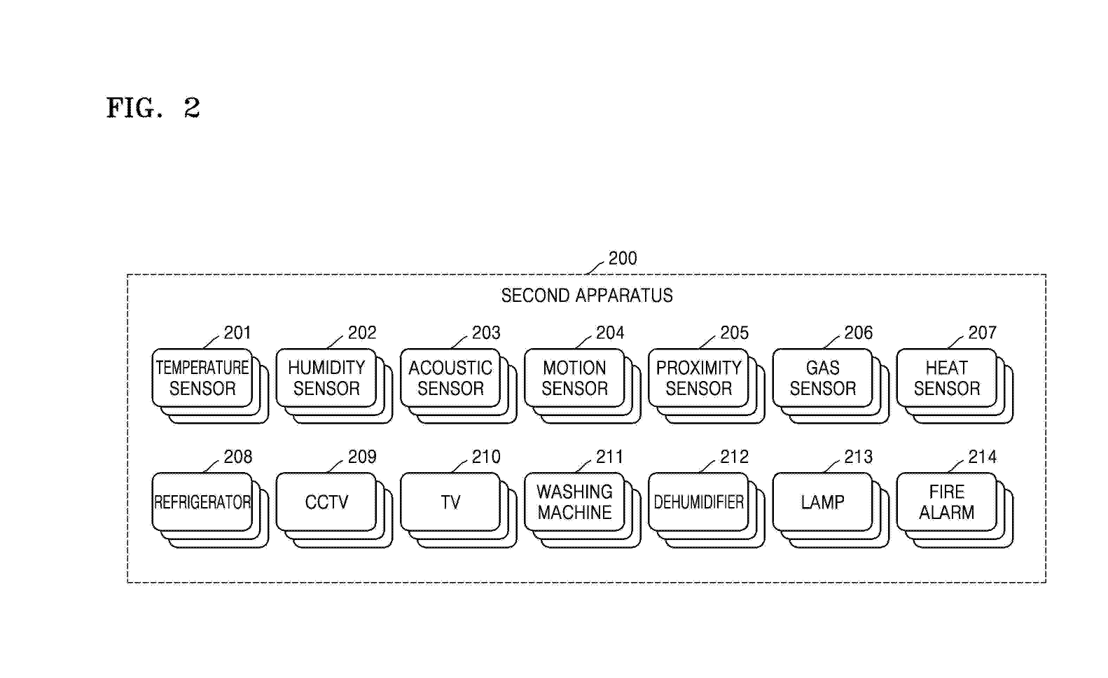

FIG. 2 is a block diagram of a second apparatus or apparatuses 200 which may include one or more of various devices according to an exemplary embodiment.

The apparatuses 200 include various types of apparatuses. A temperature sensor 201 measures a temperature. The temperature sensor 201 is a temperature sensor including a temperature sensor using mercury, a temperature patch of which a color changes at a specific temperature, an infrared temperature sensor, and a laser temperature sensor.

A humidity sensor 202 measures humidity. The humidity sensor 202 is a humidity sensor including a humidity sensor using dry and wet cell, a polymer humidity sensor, a metal oxide humidity sensor, a colloidal magnetite humidity sensor, a micro-wave humidity sensor, an iron oxide sintered film humidity sensor, and a ceramic humidity sensor.

An acoustic sensor 203 measures acoustic information. A representative example of the acoustic sensor 203 is a sensor which receives sound waves or ultrasonic waves and generates an electrical signal, as a microphone. The acoustic sensor 203 includes a sensor which measures the size of a sound, or a sensor which extracts only specific sound waves from complex sound waves.

A motion sensor 204 senses a movement of a device. The motion sensor 204 includes a gyro sensor, an acceleration sensor, and the like included in the device.

A proximity sensor 205 senses a thing that is around the device and approaches the device. The proximity sensor 205 may sense a change in a signal around the device by using electromagnetism or an electrostatic capacitance method, and thus sense an approach to the device.

A gas sensor 206 senses gas. The gas sensor 206 may check whether specific gas is detected. Examples of the gas sensor 206 may include an infrared gas detector and a gas analyzer.

A heat sensor 207 may include, for example, a fire detection sensor which senses heat due to a fire, an infrared heat sensor, and an influenza heat sensor.

A device in an exemplary embodiment may include a sensor and may also include apparatuses connectable to the Internet, such as a refrigerator 208, a CCTV 209, a TV 210, a washing machine 211, a dehumidifier 212, a lamp 213, and a fire alarm 214. Also, each of the sensor or the device category may include a plurality of sensors or devices, e.g., a plurality of temperature sensors, a plurality of refrigerators, etc.

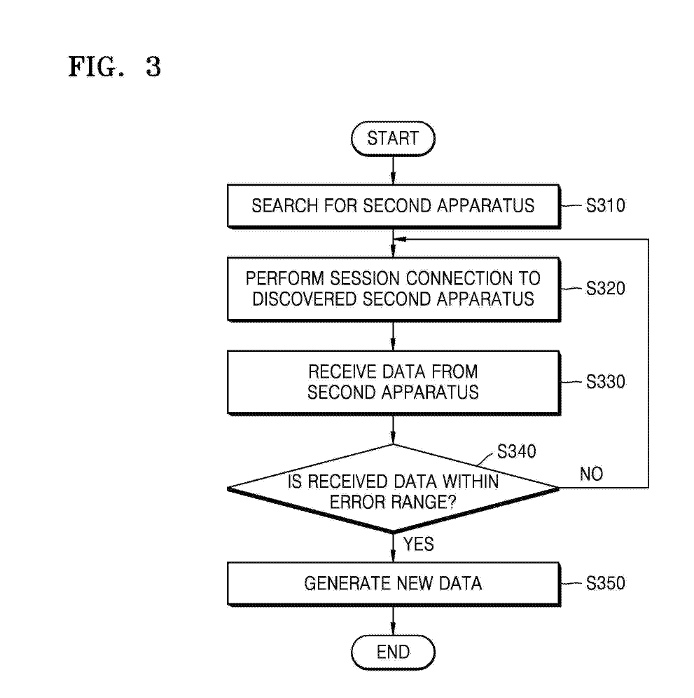

FIG. 3 is a flowchart of a method, performed by a first apparatus 100, of generating new data, according to an exemplary embodiment.

In operation S310, the first apparatus 100 may search for a second apparatus that is around the first apparatus 100 and is capable of providing information to the first apparatus 100. In the IoT environment, information of a peripheral apparatus may be utilized as information that is relevant to the first apparatus 100, as for example, nature environment information including a temperature, humidity, a brightness, and dust, and city environment information including such as a CCTV image, a public transportation schedule, and a street jam degree, etc.

The first apparatus 100 may search for the peripheral apparatus according to various criteria. For example, the first apparatus 100 may search for all possible apparatuses. Since the first apparatus 100 does not know what information is to be received from what apparatus, the first apparatus 100 may search for all peripheral apparatuses around the first apparatus 100 in order to utilize all pieces of information.

The first apparatus 100 may be set to search for only specific apparatuses. The first apparatus 100 may search for only an apparatus corresponding to a smartphone, or search for only a CCTV camera whose location is fixed. For example, the first apparatus 100 may be set to search for only apparatuses that are within a 30 m radius of the first apparatus 100. For example, the first apparatus 100 may measure the intensity of a reception signal and calculate the distance. For example, the first apparatus 100 may be set to search for only apparatuses that are owned by a user of the first apparatus 100.

The first apparatus 100 may transmit a discovery request message to the peripheral apparatus. The discovery request message may be transmitted as a broadcast, a multicast, or a unicast. The second apparatus that has received the discovery request message from the first apparatus 100 may transmit a discovery response message to the first apparatus 100 in response to the discovery request message. In response to the discovery response message, the first apparatus 100 may recognize, e.g., identify, the second apparatus and complete a discovery process. When a plurality of apparatuses are discovered, the discovery request message may be continuously transmitted.

In operation S320, the first apparatus 100 may perform session connection to a discovered second apparatus. Since the first apparatus 100 needs to receive various pieces of information from the second apparatus, session connection is necessary. The first apparatus 100 that has discovered N second apparatuses may maintain connection with each of the N second apparatuses. Alternatively, a broker apparatus may exist between the first apparatus 100 and the N second apparatuses, and thus the first apparatus 100 may communicate with the broker apparatus and the broker apparatus may mediate connection between the first apparatus 100 and the N second apparatuses. For example, a first apparatus 100, which is a smartphone, may communicate with a broker apparatus corresponding to a server, and the server may be connected to a plurality of second apparatuses to be communicated therewith.

The first apparatus 100 may maintain an information transmission path between the first apparatus 100 and the second apparatus without the session connection method. The first apparatus 100 may be set to receive data the second apparatus in a state-less method.

In operation S330, the first apparatus 100 may receive data from the second apparatus. The data received from the second apparatus may be information sensed by the second apparatus, or may be information stored in the second apparatus. For example, the data received from the second apparatus may be information received by the second apparatus from other apparatuses. For example, the first apparatus 100 may receive CCTV image data from a CCTV fixed to a particular location. As another example, the first apparatus 100 may receive subway traffic information from an apparatus of another user.

The first apparatus 100 may receive data from the second apparatus in response to a data request message of the first apparatus 100. The data request message may be transmitted every time the first apparatus 100 needs information about the second apparatus. The second apparatus may transmit requested data every time the data request message is received. For example, every time the first apparatus 100 requests the second apparatus for location information, the second apparatus may transmit the location information of the second apparatus.

Alternatively, the second apparatus may transmit data periodically or every time an event occurs, according to the data request message of the first apparatus 100. For example, the second apparatus may receive a request message with respect to temperature information from the first apparatus 100, and may transmit temperature information every hour, or may transmit temperature information every time a temperature changes by one degree.

The second apparatus may additionally perform authentication with respect to the data request message of the first apparatus 100. The second apparatus may determine that the first apparatus 100 is capable of receiving data of the second apparatus, based on information about the first apparatus 100 that is included in the data request message of the first apparatus 100. For example, the second apparatus may determine whether the first apparatus 100 subscribes to the information of the second apparatus, based on ID information of the first apparatus 100. For example, the second apparatus may measure the intensity of a reception signal of the data request message of the first apparatus 100 and determine a physical distance of the first apparatus 100 with respect to the second apparatus. The second apparatus may determine whether to transmit data to the first apparatus 100, according to the determined distance not being greater than a certain value.

In operation S340, the first apparatus 100 may determine whether the received data is within an error range. The received data may be data received according to a request of the first apparatus 100, or may be data received without request messages. Accordingly, the first apparatus 100 may perform filtering to improve purpose suitability and reliability of the data.

When it is determined that information received from the second apparatus is information that is irrelevant to the first apparatus 100, the first apparatus 100 may store separately or delete the received irrelevant information for better management of the storage capacity, such as securing of a space where to store a significant amount of information and reduction of power consumption. For example, the first apparatus 100 may request the second apparatus for data to determine a location of the second apparatus, but, when temperature information is received from the second apparatus, the first apparatus 100 may store the temperature information in a server or delete the temperature information from a storage of the first apparatus 100.

The controller 110 of the first apparatus 100 may first set an error range in order to determine whether the received data is within the error range. For example, when the received data is location information, only location information that is within a 200 m radius of the first apparatus 100 may be utilized. For example, when the received data is temperature information, temperature information required by the first apparatus 100 may be set as information representing a temperature between 10° C. and 30° C. In this case, when temperature information of 50° C. is received from the second apparatus, the temperature information may be determined to be incorrectly measured or irrelevant.

A criterion for the filtering may be set by a user or set by an apparatus. As the error range of filtering becomes narrower, purpose suitability and reliability of the received data may increase.

In operation S350, the controller 110 of the first apparatus 100 may generate new data, based on the received data. The controller 110 of the first apparatus 100 may generate context information, based on the received data and data pre-stored in the first apparatus 100.

The context information includes information about situations of a current user or device. For example, the context information may correspond to a location of a user of a current device, a pressure at the location, and illumination at the location. For example, the context information may correspond to an application being executed by the device, performance of the device, or information about an apparatus around the device.

For example, the controller 110 of the first apparatus 100 may determine a discomfort index of a user at a location where the first apparatus 100 is positioned, based on location information of the first apparatus 100 measured by the first apparatus 100, and location information, temperature information, and humidity information of the second apparatus received from the second apparatus. The first apparatus 100 may generate comforting information that may be used to lower a discomfort index of a current user. For example, when it is determined that a sensory temperature and/or discomfort index of a user deviates from a normal range, the first apparatus 100 may change settings of an air conditioner around the user, recommend bookmark music of the user, or search for a coffee shop around the user and display a found coffee shop.

The first apparatus 100 may generate various complex data. The generated data may be stored in the storage 120 of the first apparatus 100. The generated data may be classified according to the types of data and stored in the storage 120 of the first apparatus 100. The first apparatus 100 may classify videos, images, and pictures by type and store the same. Alternatively, the first apparatus 100 may store the generated data in a separate storage inside or outside the apparatus 100. The separate storage within the apparatus 100 may correspond to random access memory (RAM), flash memory, and the like, and the separate storage outside the apparatus 100 may correspond to a cloud server, a network attached storage (NAS), and the like.

The first apparatus 100 may link the data stored in the storage 120 with the data stored in the separate storage. The first apparatus 100 may synchronize data stored in different storages with each other. The first apparatus 100 may set data that is stored beyond a certain period of time to be deleted, thereby vacating a storage space.

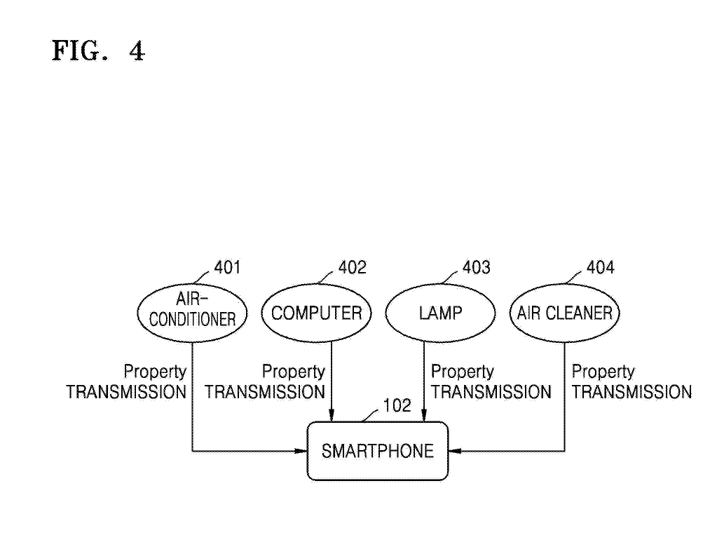

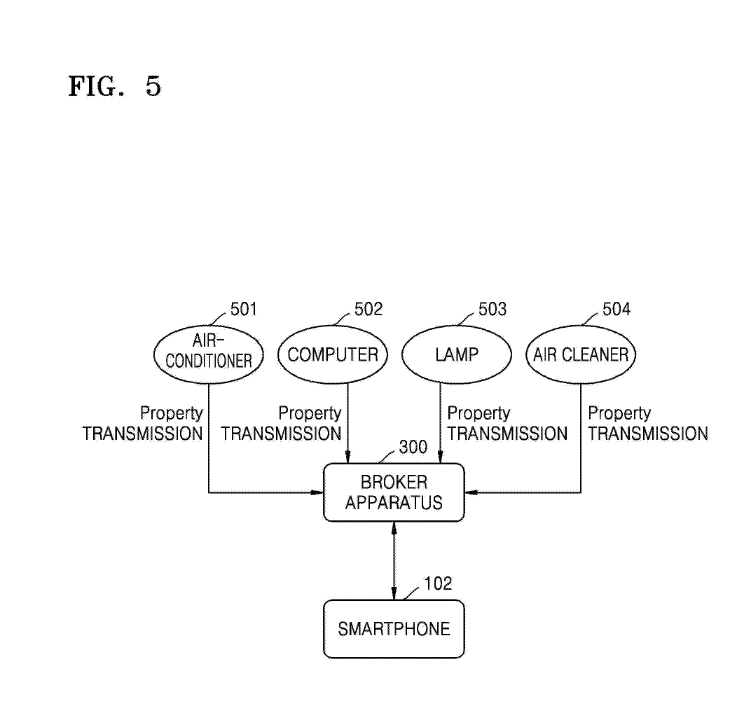

FIGS. 4 and 5 illustrate examples in which a first apparatus receives information from another device, according to an exemplary embodiment.

FIG. 4 illustrates a case where the first apparatus 100 includes a smartphone 102 which directly receives data from the other device. When the first apparatus 100 is a smartphone 102, the smartphone 102 may interoperate with various home appliances within a house, in order to perform a smart home. The smartphone 102 may receive various data from an air-conditioner 401, a computer 402, a lamp 403, and an air cleaner 404.

When the first apparatus 100 directly receives data from another apparatus, a favorable effect may appear in a small-sized network. For example, the number of home appliances existing within a house is limited, and load in terms of a processing amount and a storage space, e.g., computer memory capacity, may be small when the first apparatus 100 manages received data. However, since numerous apparatuses operate in a space, such as a subway or department store crowded with people, and are connected to one another via a network, the first apparatus 100 may have a great amount of load in terms of physical performance when processing received data.

For example, when the first apparatus 100 directly receives data from another apparatus, the first apparatus 100 may receive data from a specific second apparatus requested by the first apparatus 100 to transmit the data. Even when various second apparatuses are located around the first apparatus 100, the first apparatus 100 does not transmit a data request message to all of the second apparatuses, but may transmit the data request message to only a second apparatus having communicated with the first apparatus 100 or to only a currently necessary type of apparatus. For example, the first apparatus 100 at a department store may request only elevators for location information in order to determine current locations of the elevators, and receive location information from the elevators that have received a data request message.

FIG. 5 illustrates a case where the first apparatus receives data from another device via a broker apparatus.

The smartphone 102 may interoperate with various home appliances within a house via the broker apparatus 300, e.g., a smart home server, in order to perform a smart home. The smart home server may receive various data from an air-conditioner 501, a computer 502, a lamp 503, and an air cleaner 504. The first apparatus 100 including the smartphone 102 may perform a desired service by communicating with the smart home server which manages the various devices.

When the first apparatus 100 receives data from another apparatus via the smart home server, a favorable effect may appear in a large-sized network. For example, since numerous apparatuses operate in a space, such as a subway or department store crowded with people, and are connected to one another via a network, the first apparatus 100 may receive desired data by connecting to the smart home server capable of managing information of the numerous apparatuses.

When the first apparatus 100 receives data of the second apparatus via the smart home server, purpose suitability and reliability of the received data may improve. Since the smart home server may store the data of the second apparatus and also arrange the received data, the first apparatus 100 may rapidly receive desired data.

The smart home server may classify the data received from the second apparatuses according to various criteria and store the classified data. The smart home server may classify the received data according to the types of second apparatuses. For example, the smart home server may group data received from the air-conditioner 501 and store the grouped data.

As another example, the smart home server may classify the data received from the second apparatus, according to the types of information. The smart home server may classify the received data into location information and temperature information and store the classified data. The various criteria used by the smart home server to classify and store received data are not limited thereto, and may be any appropriate criterion.

The first apparatus 100 may receive more purpose-suitable and reliable information when receiving data via a broker apparatus, such as the smart home server, than when directly receiving data from the second apparatuses. Since the broker apparatus 300 such as the smart home server supports the first apparatus 100 receiving data of the second apparatuses, the broker apparatus needs to have higher physical performance than the first apparatus 100.

However, the broker apparatus is not limited to a server, and may be an apparatus that is the same as or similar to a first apparatus, such as, a simple parking occupancy sensor, a peripheral smartphone, or a wearable apparatus. A broker apparatus in an exemplary embodiment is any apparatus capable of receiving data from a second apparatus and transmitting the received data to a first apparatus.

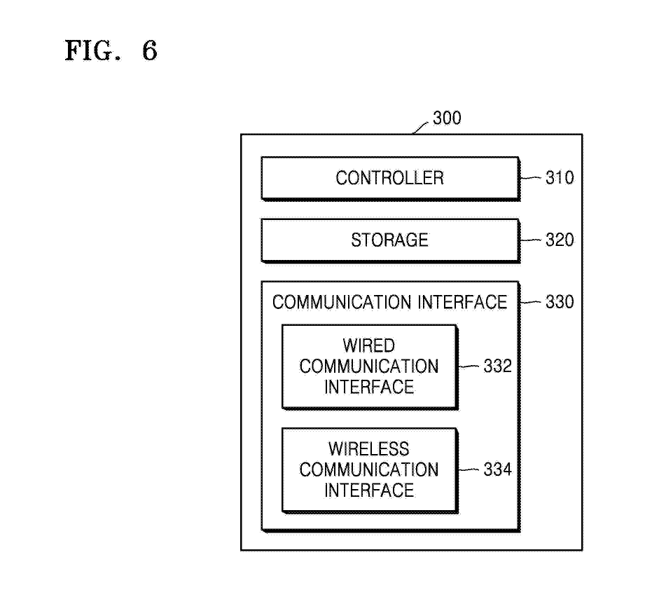

FIG. 6 is a block diagram of a broker apparatus 300 according to an exemplary embodiment.

Referring to FIG. 6, the broker apparatus 300 may include a controller 310, e.g., a microprocessor, a storage 320, and a communication interface 330. The communication interface 330 may include a wireless communication interface 332 and a wired communication interface 334.

The controller 310 may be set to transmit data received from second apparatuses to the first apparatus 100. The controller 310 may process and/or classify the data received from the second apparatuses or generate new data from the received data.

The controller 310 may group the data received from the second apparatuses according to the types of second apparatuses. For example, the broker apparatus 300 may receive various pieces of information from various second apparatuses and classify the received pieces of information according to the types of second apparatuses, such as, a temperature sensor, a GPS, and an image sensor, e.g., a camera.

The controller 310 may group the data received from the second apparatuses according to the types of data. For example, various types of data, such as images, data, and audio, may be classified according to the types of data and stored.

The controller 310 may generate new data by processing the data received from the second apparatuses. For example, the controller 310 may generate sensory temperature information by combining temperature information with humidity information, or determine a current situation, based on location information and noise information. When small noise information is received from a smartphone within a theater, the controller 310 may determine that a movie is being played, and generate setting information that lowers the brightness of a screen of the smartphone.

The storage 320 may store information received from the second apparatuses and also store generated context information. The storage 320 may also store information about a list of services executable by the first apparatus 100. The storage 120 may store, as a DB, execution histories of services currently being executed by the second apparatuses.

The communication interface 330 may communicate with another apparatus or a sensor. The communication interface 330 may communicate with a network apparatus such as a server, and this communication may be performed by wires or wirelessly. The communication interface 330 may perform communication to receive sensing information of an apparatus such as a sensor apparatus and may perform communication to transmit information of the apparatus 100 to another device.

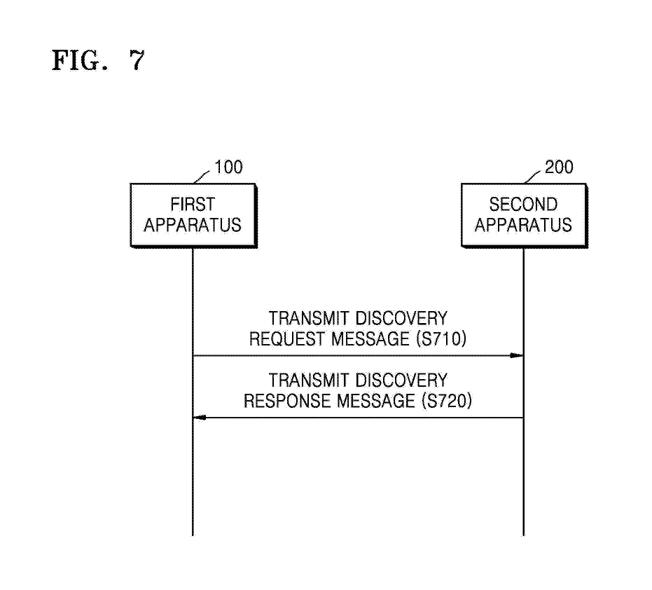

FIG. 7 is a flowchart of a method, performed by a first apparatus 100, of discovering a second apparatus 200, according to an exemplary embodiment.

In operation S710, the first apparatus 100 may transmit a discovery request message to discover the second apparatus 200. The discovery request message may be transmitted as a broadcast, a multicast, or a unicast.

The broadcast transmits the discovery request message of the first apparatus 100 to all apparatuses around the first apparatus 100, the multicast transmits the discovery request message of the first apparatus 100 to apparatuses that are set to receive information of the first apparatus 100, and the unicast transmits the discovery request message to only a specific apparatus. Thus, the first apparatus 100 may transmit the discovery request message in an appropriate manner according to how the first apparatus 100 and the second apparatus 200 form a network.

In the IoT environment, information of a peripheral apparatus may be utilized as information that is relevant to the first apparatus 100, as for example, nature environment information including a temperature, humidity, a brightness, and dust, and city environment information including a CCTV image, a public transportation circumstance, and a street traffic degree.

The first apparatus 100 may search for the peripheral apparatus according to various criteria. For example, the first apparatus 100 may search for all possible apparatuses. Since the first apparatus 100 does not know what information is to be received from what apparatus, the first apparatus 100 may search for all peripheral apparatuses around the first apparatus 100 in order to utilize all pieces of information.

The first apparatus 100 may be set to search for only specific apparatuses. The first apparatus 100 may search for only an apparatus corresponding to a smartphone, or search for only a CCTV camera whose location is fixed. Alternatively, the first apparatus 100 may be set to search for only apparatuses that are within a 30 m radius of the first apparatus 100. For example, the first apparatus 100 may measure the intensity of a reception signal and calculate the distance. Alternatively, the first apparatus 100 may be set to search for only apparatuses that are owned by a user of the first apparatus 100.

In operation S720, the second apparatus 200 that has received the discovery request message from the first apparatus 100 may transmit a discovery response message to the first apparatus 100 in response to the discovery request message. In response to the discovery response message, the first apparatus 100 may recognize existence of the second apparatus 200 and complete a discovery process. When a plurality of apparatuses are discovered, the discovery request message may be continuously transmitted.

The second apparatus 200 may transmit the discovery response message to a broker apparatus 300. The broker apparatus 300 may receive the discovery response message and transmit the same to the first apparatus 100, and the first apparatus 100 may receive discovery information arranged or grouped by the broker apparatus 300.

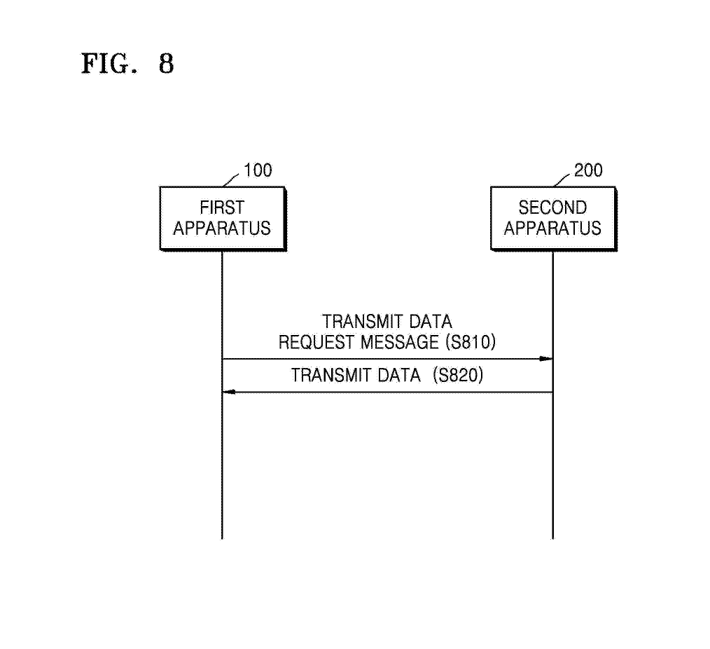

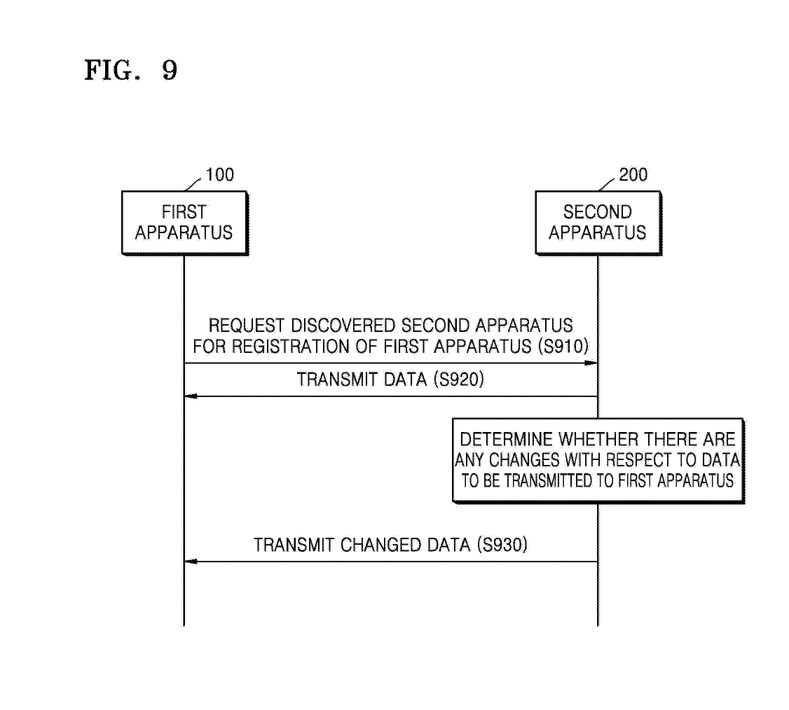

FIGS. 8 and 9 illustrate examples in which the first apparatus 100 receives data, according to an exemplary embodiment.

FIG. 8 illustrates an example in which the first apparatus 100 receives data from the second apparatus 200. In operation S810, the first apparatus 100 may transmit a data request message to the second apparatus 200 in order to acquire sensing information of a discovered second apparatus 200.

The first apparatus 100 may request information measured by the second apparatus 200, information stored in the second apparatus 200, or information about the second apparatus 200. For example, when the second apparatus 200 is a CCTV camera, the first apparatus 100 may request video data currently being captured by the second apparatus 200. When the second apparatus 200 is a smartphone, the first apparatus 100 may request the second apparatus 200 for audio data stored in the second apparatus 200 or information about performance of the smartphone.

In operation S820, the second apparatus 200 may transmit data in response to the data request message of the first apparatus 100. The data transmitted by the second apparatus 200 may be data requested by the first apparatus 100. Alternatively, the data transmitted by the second apparatus 200 may be data related to the data requested by the first apparatus 100. For example, the first apparatus 100 may request the second apparatus 200 for location information in order to ascertain a location of the second apparatus 200, and the second apparatus 200 may transmit to the first apparatus 100 location information of the second apparatus 200 that is measured by a GPS within the second apparatus 200. Alternatively, the second apparatus 200 may transmit specific application information related to the location information to the first apparatus 100, and thus the first apparatus 100 may determine a location of the second apparatus 200. For example, when the second apparatus 200 is purchasing a product in a store, the second apparatus 200 may transmit to the first apparatus 100 information about products currently being purchased and schedule information instead of location information representing the store so that the first apparatus 100 may determine that the second apparatus 200 is in a store.

FIG. 9 illustrates another example in which the first apparatus 100 receives data from the second apparatus 200, according to an exemplary embodiment.

In operation S910, the first apparatus 100 may request registration of a discovered second apparatus 200 with respect to the first apparatus 100. In more detail, the registration request means requesting the second apparatus 200 to allow the first apparatus 100 to be registered as an apparatus which is to receive data from the second apparatus 200.

In operation S920, the second apparatus 200 may accept the registration request of the first apparatus 100, and, in this case, may transmit data to the first apparatus 100. When the second apparatus 200 refuses the registration request of the first apparatus 100, the first apparatus 100 may fail to receive data from the second apparatus 200.

The second apparatus 200 may determine whether there are any changes with respect to data to be transmitted to the first apparatus 100. For example, temperature information may be requested by the first apparatus 100, and the second apparatus 200 may determine that the temperature information has changed after being transmitted to the first apparatus 100.

In operation S930, the second apparatus 200 may transmit changed data to the first apparatus 100. The first apparatus 100 may receive the changed data and update the existing data with the received changed data. Accordingly, the first apparatus 100 may acquire most recent information of the second apparatus 200.

Every time data changes, the second apparatus 200 may transmit changed data to the first apparatus 100 registered in the second apparatus 200, and the first apparatus 100 may determine whether data of the second apparatus 200 has changed. Since the first apparatus 100 is unable to directly determine whether data of the second apparatus 200 has changed, the first apparatus 100 receives changed data every time data changes, and thus does not need to periodically transmit the data request message.

The method of transmitting changed data to the first apparatus 100 every time data of the second apparatus 200 changes, described above with reference to FIG. 9, may be useful in a case where data of the second apparatus 200 irregularly changes or where it is difficult for the first apparatus 100 to periodically or non-periodically transmit the data request message.

For example, data measured by the second apparatus 200, such as temperature, humidity, or location information, is variable, the second apparatus 200 may transmit the measured data to the first apparatus 100 so that the first apparatus 100 maintains most recent data. For example, when temperature information in the second apparatus 100 has changed to 20° C., 21° C., and 20° C. at 3 pm, 4 pm, and 5 pm, respectively, and the first apparatus 100 has transmitted the data request message at 3 pm and 5 pm, the first apparatus 100 may fail to check the temperature information changed at 4 pm, and may determine that the temperature remained 20° C. between 3 pm and 5 pm. However, every time the temperature changes, the second apparatus 200 transmits changed data to the first apparatus 100, and thus the first apparatus 100 receives more accurate information.

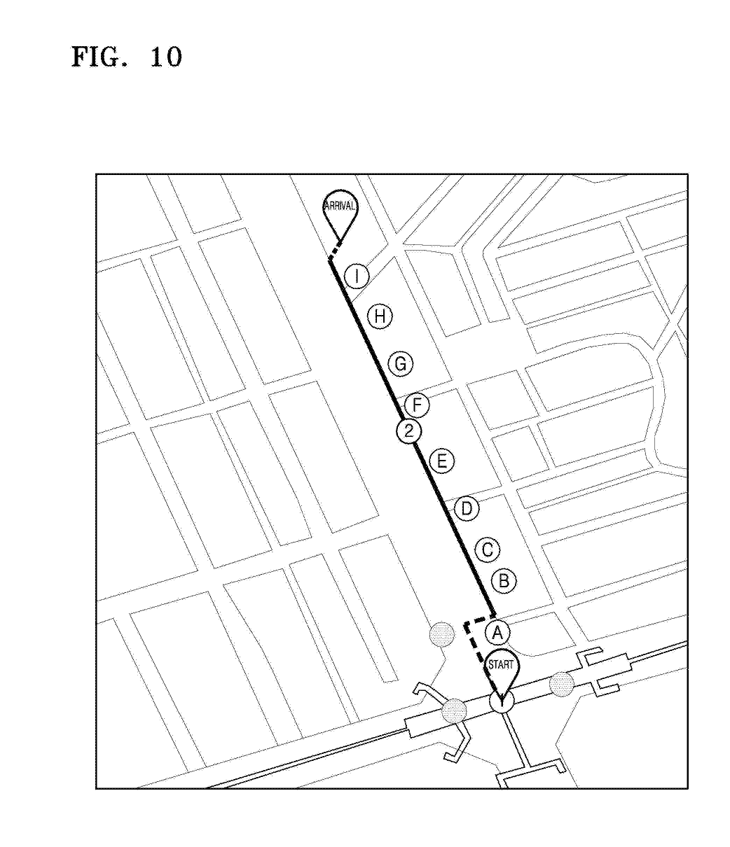

FIG. 10 illustrates a method, performed by a device, of performing a pathfinding service by using information about a peripheral apparatus, according to an exemplary embodiment.

As shown in FIG. 10, a user of the device may display location information of the device while moving with the device. FIG. 10 explains a method of receiving data from a peripheral device, and performing pathfinding. For example, the device may be the first apparatus 100 which may include a smartphone and the peripheral device may be the second apparatus 200.

The user may pass from a departure point A to an arrival point I, namely, through points A, B, C, D, E, F, G, H, and I. The device of the user may transmit a discovery request message to peripheral devices at the point A on a moving path of the user, and receive discovery response messages from the peripheral devices. The device of the user may request discovered peripheral devices for location data and receive location information at the point A from the discovered peripheral devices. Thereafter, the device of the user may transmit a discovery request message to peripheral devices at a point B while moving to the point B, and may receive discovery response messages from the peripheral devices. The device of the user may request the discovered peripheral devices for application information that is currently being used. The peripheral devices may transmit application information that is currently being operated, to the device of the user. For example, theater reservation application information may occupy a large part of application information received from peripheral devices at the point B. The device of the user may determine that the device of the user is at the point B, which is around a theater, based on the location information at the point A and the application information at the point B. The device of the user may determine a path to the point I as the arrival point, from the moving path from the point A to the point B.

The device of the user may receive advertisement data of peripheral devices while moving along the moving path. The device of the user may determine whether the device moves along the moving path, by determining current locations of the peripheral devices based on the received advertisement data. For example, the device of the user may receive advertisement music as audio data from a coffee shop at a point F and identify the coffee shop, and may determine based on location information of the identified coffee shop that the device of the user is currently around the point F. In this case, the device of the user may search for location information of franchise coffee shops where the same advertisement music is being played, via a server and the like. Information about coffee shops far away from the current location of the device does not satisfy an error range, and thus may be excluded from the determination. Thus, the device of the user may become aware of approaching the point I, which is the arrival point.

The device of the user may receive image information captured by peripheral devices at the point I, which is the arrival point, determine current locations of the peripheral devices from information about text and objects included in the received image information, and determine that the device of the user has arrived at the point I, which is an arrival destination.

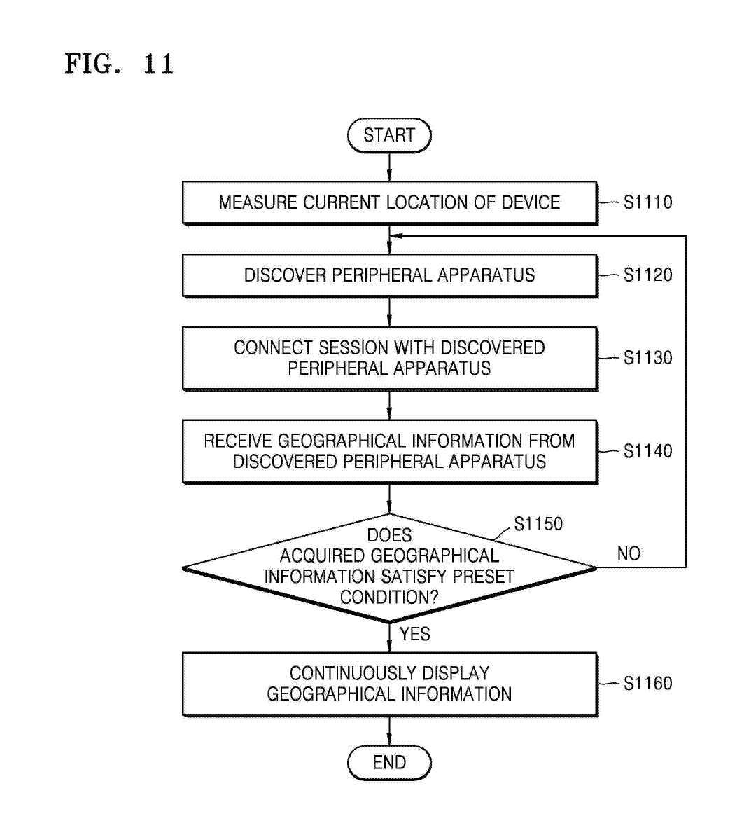

FIG. 11 is a flowchart of a method, performed by a device, of performing pathfinding, according to an exemplary embodiment. For example, the device may be the first apparatus 100 which may include a smartphone.

As described above with reference to FIG. 10, the device may display a current location to a user while performing pathfinding, and data may be received from a peripheral device via a series of processes below.

In operation S1110, the device may measure the current location thereof. In detail, the device may acquire current location information from a GPS sensor or an access point (AP).

In operation S1120, the device may transmit a discovery request message to discover a peripheral apparatus that is to be quested for data. The device may receive a discovery response message from a peripheral apparatus having received the discovery request message, and thus discover the peripheral apparatus. For example, the peripheral apparatus may be the second apparatus 200.

In operation S1130, the device may connect a session with the discovered peripheral apparatus. Thereafter, the device may perform authentication and the like to receive data.

In operation S1140, the device may receive geographical information from the discovered peripheral apparatus. The device may receive measured or acquired geographical information from the discovered peripheral apparatus and thus determine the current location of the device based on the received geographical information.

In operation S1150, the device may determine whether the acquired geographical information satisfies a preset condition. For example, when location information measured within the last 10 minutes is set as the preset condition, the device may determine whether the geographical information received from the peripheral apparatus is within the past 10 minutes, and thus determine whether the received geographical information is to be utilized as basic data for determining the current location.

In operation S1160, the device may display the determined current location information to provide the determined current location information to the user. As the device of the user moves, the device of the user may repeat the above-described processes and may display changed location information.

The operations S1110 through S1160 are illustrated for convenience of explanation, and exemplary embodiments are not limited thereto. Some operations may be added to the operations S1110 through S1160 or some of operations S1110 through S1160 may be omitted.

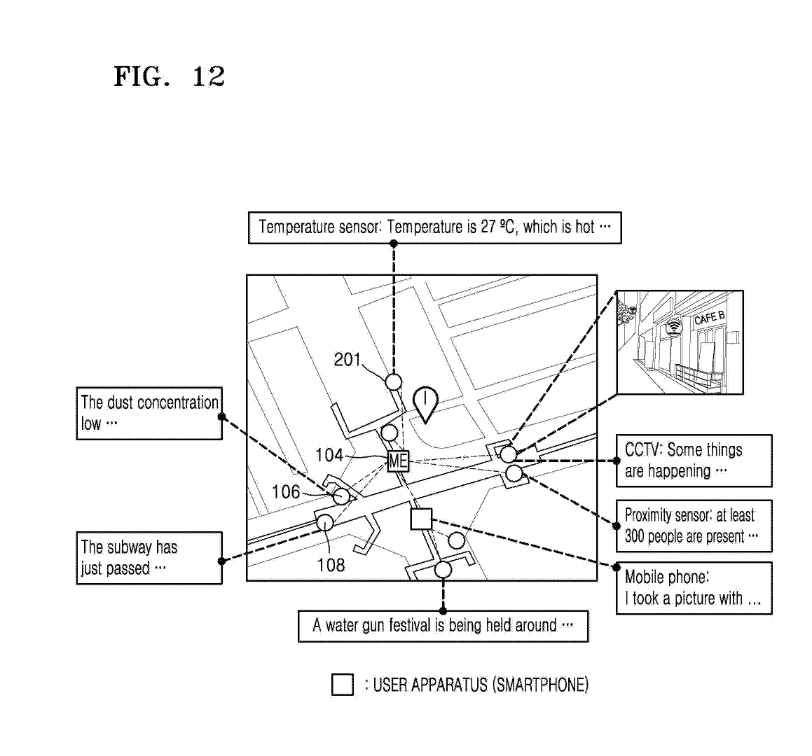

FIG. 12 illustrates a method, performed by a device, of generating metadata by using information about a peripheral apparatus, according to an exemplary embodiment. For example, the device may be the first apparatus 100 which may include a smartphone and the peripheral apparatus may be the second apparatus 200.

The device may generate the metadata from the information about the peripheral device. The device may combine information sensed by the peripheral device or the device with each other to generate single metadata, and may extend the generated metadata.

As shown in FIG. 12, a device 104 of a user may receive various types of data from many peripheral apparatuses around the device, at a current location. The device may receive, from a device including a temperature sensor 201, information indicating that a current temperature is 27° C. and corresponds to a hot day compared with average temperature data. The device may receive, from a sensor 106 capable of measuring the air quality, information indicating that a dust concentration around the device is low. The device may receive, from a traffic information server 108, information indicating that a subway train has just departed at the current location of the device. In response to various types of information received from various other apparatuses, the device may filter the received information to exclude information having low reliability or the information which is irrelevant.

The device may combine the received various types of information with each other to generate single metadata. For example, single context information which is current circumstances around the device may be linked with various types of information. For example, the device may search for a keyword ‘atmosphere pollution information of a region A’ from a web server or the like, and link a result of the search with corresponding context information.

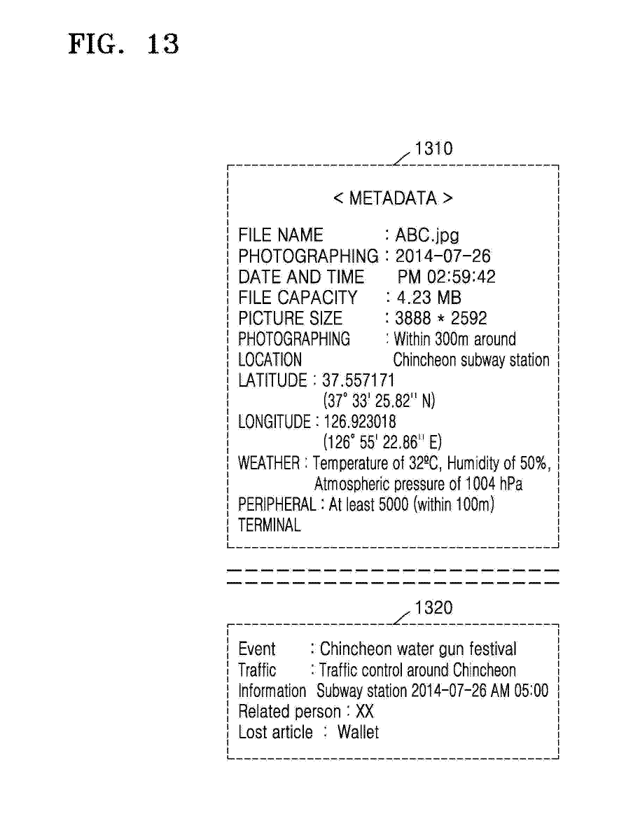

FIG. 13 illustrates an example of metadata that is generated by a device, according to an exemplary embodiment.

As shown in FIG. 13, the device may link related context information to each other and utilize the linked context information as single metadata when generating image or video content. For example, the device may be the first apparatus 100 which may include a smartphone.

As shown by metadata 1310, the device may combine various types of information, such as, a file name of an image captured by the device, a capturing date and time, and a file capacity, and also other information received from the periphery of the device, for example, location data and weather, to thereby generate single metadata.

For example, the device may search for a subway station related to a location where a peripheral apparatus performs photography from a web server, and thus determine that a festival is being held in the location and reflect this information as metadata 1320. The device may determine that at least 5000 people are gathered, by referring to the fact that a festival is being held at the location of the device and that at least 5000 smartphones are discovered or identified. The device may determine which people attend the festival or which events are related to the festival, by searching for information related to the festival. If a user loses his or her wallet in the festival place, loss information may be received and used to find the owner of the lost article.

The device may generate captured image information and single metadata from various pieces of related sensing information and received information.

The device may generate a diary based on the generated metadata. For example, the device may generate single metadata from metadata of each captured image. The device may arrange images according to time zones and display the arranged images, or may classify the images according to circumstances of images and display the classified images.

For example, as for captured images or videos, the device may display only data captured within a house or display only data captured during a school class. The device may display only videos captured in a smart class. Various criteria for classifying metadata may be set by a user, and the arrangement is possible according to a single criterion and/or a combination of a plurality of criteria.

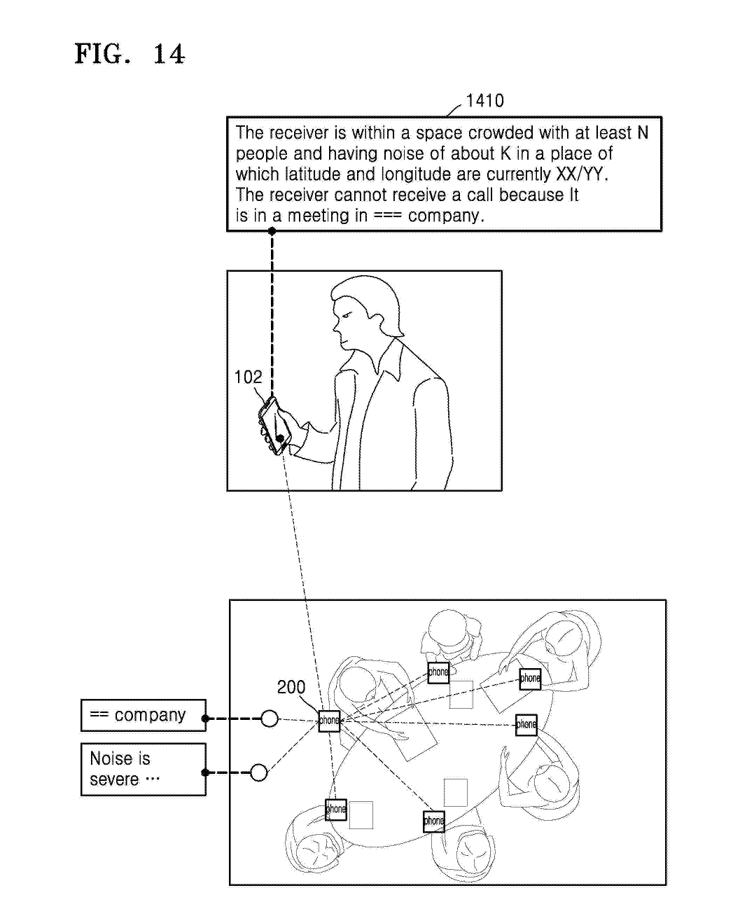

FIG. 14 illustrates a method, performed by a device, of generating metadata by using information about a peripheral apparatus, according to an exemplary embodiment. For example, the device may be the first apparatus 100 which may include a smartphone and the peripheral apparatus may be the second apparatus 200.

As shown in FIG. 14, a device of a user may acquire context metadata information 1410 by receiving information about a peripheral apparatus during a call connection. A first apparatus of the user may transmit a transmitting signal to perform call connection with a second apparatus. When a user of the second apparatus, which is a reception device, is in a meeting, namely, when a call between the first apparatus and the second apparatus is difficult, the second apparatus may transmit context information of the second apparatus to the first apparatus.

The context information of the second apparatus may be information measured by the second apparatus. For example, a microphone sensor of the second apparatus may measure noise around the second apparatus, and a GPS or an AP of the second apparatus may measure location information (for example, a conference room) of the second apparatus. In an active measuring manner, the second apparatus may transmit a discovery request message to a peripheral apparatus and receive a discovery response message in response to the discovery request message, thereby acquiring information about the number of peripheral apparatuses around the second apparatus.

The second apparatus may transmit measured or acquired context information of the second apparatus to the first apparatus. The first apparatus may determine that the user of the second apparatus is currently having a meeting with some people and is thus unable to talk on the phone, based on the received context information. The first apparatus may store new context information indicating that the user of the second apparatus is currently in a meeting.

The first apparatus may further expand the context information of the second apparatus. For example, when it is determined that the user of the second apparatus is currently in a meeting, the first apparatus may transmit meeting materials related to the user of the second apparatus to the second apparatus, via a verification procedure and the like with respect to the user of the first apparatus. The first apparatus may cumulatively store schedule information related to the user of the second apparatus and thus may use a basis for determination when subsequently generating new context information in connection with the second apparatus.

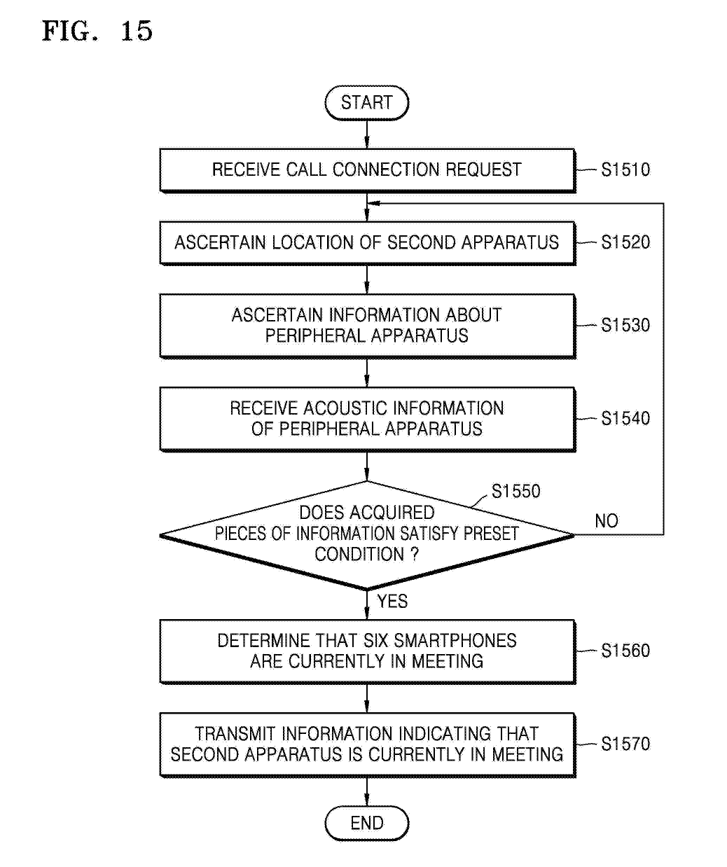

FIG. 15 is a flowchart of a method, performed by a device, of generating metadata, according to an exemplary embodiment. For example, the device may be the first apparatus 100 which may include a smartphone.

In operation S1510, the second apparatus may receive a call connection request from the first apparatus. When a call with the second apparatus is not conducted for a certain period of time, the first apparatus may request for the second apparatus for context information. Alternatively, the first apparatus may request the second apparatus for context information simultaneously when transmitting a call connection request message.

In operation S1520, when the second apparatus fails to receive a call connection acceptance input from a user of the second apparatus, the second apparatus may ascertain a location thereof. For example, a geographical location such as a latitude and a longitude and/or a character or a landmark (for example, a museum) of the location of the second apparatus may be determined as the location of the second apparatus by using a GPS or AP of the second apparatus.

In operation S1530, the second apparatus may ascertain information about a peripheral apparatus. The second apparatus may receive a discovery response message from the peripheral apparatus by transmitting a discovery request message to the peripheral apparatus, and accordingly may search for the peripheral apparatus. Information about the found peripheral apparatus may include information about the existence of the found peripheral apparatus and various information such as the type of peripheral apparatus, the performance thereof, and a currently-operating application.

In operation S1540, the second apparatus may receive acoustic information of the peripheral apparatus. The second apparatus may receive acoustic information input via a microphone sensor of the second apparatus and/or the acoustic information measured by another peripheral apparatus, which is discovered, for example, by the second apparatus.

In operation S1550, a controller of the second apparatus may determine whether acquired pieces of information satisfy a preset condition. For example, since the controller may receive common location information from a plurality of apparatuses but may also receive incorrectly measured location information from a certain apparatus, the controller may perform filtering to improve the reliability of information.

The controller may perform filtering on incorrectly measured information and filtering according to the type of information. For example, although the controller has received image information from peripheral apparatuses of the second apparatus, if the received image information is set to be unnecessary, the received image information may be separately stored or deleted.

In operation S1560, the second apparatus may generate context information, based on filtered information. For example, when the second apparatus discovers six smartphones within a conference room A and the intensities (dB) of pieces of acoustic information respectively measured by the six smartphones are compared with one another, the second apparatus may determine that the six smartphones are currently in a meeting.

As another example, the second apparatus may receive information indicating that 120 smartphones have been discovered within a theater B and have all been set in a vibrating mode. The second apparatus may determine that a movie is currently being played, based on the above-described pieces of information.

In operation S1570, the second apparatus may transmit, to the first apparatus having requested a call connection, information indicating that a user of the second apparatus is currently in a meeting. For example, the second apparatus may transmit a message such as “In a meeting” to the first apparatus or transmit, to the first apparatus, image information representing that the second apparatus is currently in a meeting.

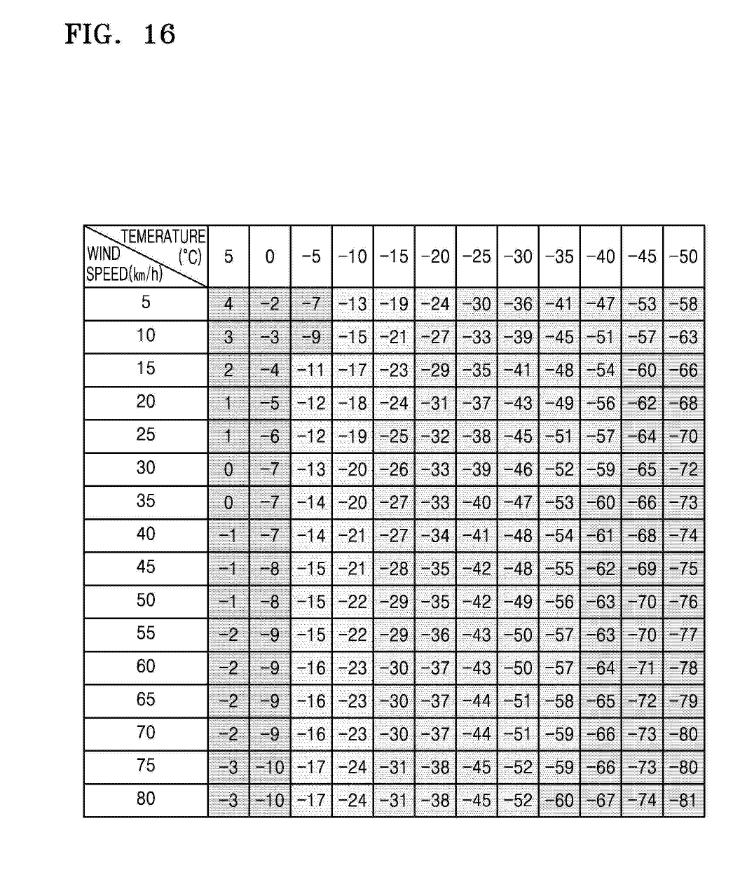

FIG. 16 is a table for describing a method, performed by a device, of generating sensory temperature information that is generated in new data, according to an exemplary embodiment. For example, the device may be the first apparatus 100 which may include a smartphone.

Although a first apparatus may include various sensors, it is actually difficult to include many sensors due to limitations in terms of, for example, physical space and power consumption. Thus, the first apparatus may request a peripheral apparatus for necessary data and generate context information based on received data. For example, the peripheral apparatus may be the second apparatus 200.

For example, the first apparatus includes a temperature sensor and thus may measure a temperature around the first apparatus. The first apparatus may receive from a user an input instructing measurement of a discomfort index at a current location of the first apparatus. However, as shown in FIG. 16, wind speed information in addition to temperature information needs to be further acquired to measure the discomfort index.

Accordingly, the first apparatus may request a web server or another entity connected thereto for wind speed information of a location of the first apparatus, receive the wind speed information, and calculate the discomfort index according to a discomfort index calculation formula.

Alternatively, to acquire the wind speed information, the first device may discover peripheral apparatuses. The first apparatus may transmit a discovery request message to the discovered peripheral apparatuses and receive discovery response messages from the discovered peripheral apparatuses, thereby receiving information about the discovered peripheral apparatuses.

The first apparatus may select apparatuses including wind speed sensors among the discovered peripheral devices. The first apparatus may request the selected apparatuses for wind speed data. The first apparatus may receive the wind speed data from the selected apparatuses and calculate the discomfort index based on the received wind speed data.

The first apparatus may filter the data received from the peripheral apparatuses. For example, the first apparatus may exclude wind speed data representing a wind speed value that significantly deviates from an average value. Alternatively, the first apparatus may exclude wind speed data measured three minutes earlier than a current time point.

Apparatuses requested by the first apparatus for wind speed data may transmit the wind speed data to the first apparatus every time a wind speed changes, thereby supporting the first apparatus to measure a most recent discomfort index.

Apparatus information of a device according to an exemplary embodiment may be stored as a table. For example, an apparatus information table may include an apparatus ID field, an apparatus type field, a data type field, a data attribute field, and a sensing cycle field.

The apparatus ID field may record an ID value of a device, and the apparatus type field may record the type of the device. For example, the apparatus type field may record a temperature sensor, an acoustic sensor, a gas sensor, a clock, a refrigerator, a washing machine, and a fire alarm.

The data type field may record the type of sensing data sensed by the device. For example, the data type field may record a number, a sound, a character, an image, and a moving picture.

The data attribute field may record the attributes of the sensing data sensed by the device. For example, the data attribute field may record a number value, a data value, a byte value, and a string value.

The sensing cycle field may record a cycle during which the device senses the sensing data. The sensing cycle recorded in the sensing cycle field may be a default value set by the device.

Information about services usable by the device may be stored as a service information table. The service information table may include a service ID field, a necessary apparatus field, a priority 1 field, a priority 2 field, and a priority 3 field.

The service ID field may record ID values of services, and the necessary apparatus field may record information about the types and number of necessary apparatuses for providing a service. For example, the necessary apparatus field may record “two temperature sensors”, “three gas sensors”, and “one fire alarm”.

The priority 1 field may record the types and number of devices corresponding to the priority 1 among necessary devices for providing a service, the priority 2 field may record the types and number of devices corresponding to the priority 2 among the necessary devices for providing a service, and the priority 3 field may record the types and number of devices corresponding to the priority 3 among the necessary devices for providing a service. For example, the priority 1 field may record “one temperature sensor”, “one gas sensor”, and “one fire alarm”, the priority 2 field may record “one temperature sensor” and “one gas sensor”, and the priority 3 field may record “one gas sensor”.

Information recorded in the necessary apparatus field, the priority 1 field, the priority 2 field, and the priority 3 field may be used to select a minimum number of devices in order to provide a smooth service.

A service according to an exemplary embodiment may be stored as an apparatus information table showing stored apparatus information. An apparatus information table associated with the service may be obtained by further including a related service field in the apparatus information table.

The related service field may record an ID value of a service related to the device. The device or a server may determine the ID value of the service that is to be recorded in the related service field, by comparing the apparatus information table with the service information table. For example, in connection with an apparatus A, which is a temperature sensor, the related service field may record “smart home service B” and “fire alarm service A”.

A control message that a gateway according to an exemplary embodiment transmits to a device in order to control transmission of sensing data by a device will now be described.

The control message may have a value of, for example, 2 bytes. In this case, the control message may include a 1-bit value representing the type of control message, a 3-bit value representing a data processing method, a 4-bit value representing a sub-rule of the data processing method, and an 8-bit value for changing a transmission cycle of the sensing data.

The 1-bit value representing the type of control message may indicate whether the control message is for pausing the transmission of the sensing data by the device. For example, when the 1-bit value representing the type of control message is 1, the control message may be a control message for allowing the device to transmit the sensing data. For example, when the 1-bit value representing the type of control message is 0, the control message may be a message for pausing the transmission of the sensing data by the device. For example, when the 1-bit value representing the type of control message is 0 and values of the remaining bits within the control message are all 1, the control message may be a message for pausing the transmission of the sensing data by the device and accumulating and storing sensed sending data.

The 3-bit value representing a data processing method may indicate how the device processes the sensing data. For example, when the 3-bit value representing the data processing method is 0, the control message may be a message for controlling the device to not process the sensing data separately. For example, when the 3-bit value representing the data processing method is 1, the control message may be a message for controlling the device to transmit an average value of the sensing data. For example, when the 3-bit value representing the data processing method is 2, the control message may be a message for controlling the device to collect and transmit the sensing data. For example, when the 3-bit value representing the data processing method is 3, the control message may be a message for controlling the device to split and transmit the sensing data. For example, when the 3-bit value representing the data processing method is 4, the control message may be a message for controlling the device to transmit only sensing data that has changed compared to previous sensing data among newly collected sensing data. For example, when the 3-bit value representing the data processing method is 5, the control message may be a message for controlling the device to collect and transmit average values of the sensing data.

The 4-bit value representing a sub-rule of the data processing method may indicate the number of times related to data processing. For example, the 4-bit value representing a sub-rule of the data processing method may indicate the number of times the sensing data is split, the number of times the sensing data are collected, or how many sensing data need to be averaged.

The 8-bit value for changing a transmission cycle of the sensing data may indicate a cycle at which the sensing data is transmitted.

The exemplary embodiments can be embodied as a storage medium including instruction codes executable by a computer such as a program module executed by the computer. A computer-readable medium can be any usable medium which can be accessed by the computer and includes all volatile and/or non-volatile and removable and/or non-removable media. Further, the computer-readable medium may include all computer storage and communication media. The computer storage medium includes volatile and/or non-volatile and removable and/or non-removable media embodied by a certain method or technology for storing information such as computer-readable instruction code, a data structure, a program module or other data. The communication medium includes the computer-readable instruction code, the data structure, the program module, or other data of a modulated data signal such as a carrier wave, or other transmission mechanism, and includes any information transmission medium.

The “unit” used herein may be a hardware component such as a processor or a circuit, and/or a software component that is executed by a hardware component such as a processor.

The respective elements described in an integrated form may be dividedly used, and the divided elements may be used in a state of being combined.

Descriptions of features or aspects within each embodiment should typically be considered as available for other similar features or aspects in other embodiments.

Although a few exemplary embodiments have been shown and described, it would be appreciated by those skilled in the art that changes may be made in the exemplary embodiments without departing from the principles and spirit of the disclosure, the scope of which is defined in the claims and their equivalents.

What is claimed is:

1. A method of performing a communication service, the method comprising:
requesting, by a first device, a second device for data;
receiving, by the first device, the data from the second device; and
generating, by the first device, new data by filtering the data received from the second device based on a filtering criterion and combining the filtered data.

2. The method of claim 1, wherein the filtering criterion is configured to filter the received data based on whether the received data corresponds to at least one among location information of the first device, environment information at a location of the first device, and information about an application currently being executed by the first device.

3. The method of claim 1, further comprising:
prior to the requesting, searching, by the first device, for the second device; and
connecting, by the first device, a session with the second device discovered by the first device.

4. The method of claim 3, wherein the searching for the second device by the first device comprises:
receiving information about the second device from a third device that stores the information about the second device.

5. The method of claim 3, wherein the connecting the session with the second device by the first device comprises connecting the session between the first device and the second device via a third device.

6. The method of claim 1, wherein the requesting the second device for the data comprises transmitting, by the first device, a data request message to the second device, and
the receiving the data from the second device comprises receiving, by the first device, the data in response to the data request message having been transmitted by the first device.

7. The method of claim 6, wherein the receiving the data from the second device comprises:
receiving, by the first device, the data in response to the data request message transmitted by the first device periodically, at time intervals.

8. The method of claim 6, wherein the generating the new data comprises:
generating the new data that satisfies the filtering criterion which is set by a user of the first device, with respect to information stored in a storage of the first device and the received data.

9. The method of claim 1, further comprising:
arranging and storing the generated new data according to services of the first device that are capable of using the generated new data.

10. The method of claim 1, further comprising:
capturing an image; and
combining, by the first device, the captured image with the generated new data.

11. A first device for performing a communication service, the first device comprising:
a communication interface configured to request a second device for data and receive the data from the second device;
a controller configured to combine the data received from the second device with each other to generate new data according to a filtering criterion; and
a storage configured to store the data received from the second device.

12. The first device of claim 11, wherein the filtering criterion is configured to filter the received data based on whether the received data corresponds to at least one among location information of the first device, environment information about a location of the first device, and information about an application currently being executed in the first device.

13. The first device of claim 11, wherein the controller is configured to search for the second device, and connect a session with the second device which has been discovered.

14. The first device of claim 11, wherein the controller is further configured to receive information about the second device from a third device that stores the information about the second device, and search for the second device based on the received information.

15. The first device of claim 11, wherein the controller is configured to connect the session between the first device and the second device via a third device.

16. The first device of claim 11, wherein the controller is configured to transmit a data request message to the second device, and to receive the data in response to the transmitted data request message.

17. A non-transitory computer-readable recording medium having recorded thereon a computer program, which, when executed by a computer, causes the computer to perform the method of claim 1.

18. A method comprising:
requesting a second device for data, by a first device;
receiving the data from the second device;
filtering the received data to remove irrelevant data based on a filtering criterion;
combining the received data, from which the irrelevant data have been removed by the filtering, into new data;
executing, by the first device, an application which provides a service to a user of the first device, based on the new data; and
outputting, by the first device, a result obtained by the executing the application.

19. The method of claim 18, wherein the filtering criterion is based on relevancy of the received data with at least one among to a current location of the first device and the application currently being executed by the first device.

20. The method of claim 18, wherein the first device includes a smartphone,
the second device is one of a plurality of peripheral devices, and
the plurality of peripheral devices includes at least one among a temperature sensor, a humidity sensor, a proximity sensor, a position sensor, a sound sensor, and a camera.
